(19) United States
(12) Patent Application Publication
(10) Pub. No.: US 2013/0344471 A1
(43) Pub. Date: Dec. 26, 2013

(54) SESSION AND MEMBER MANAGEMENT SYSTEMS AND METHODS

(71) Applicant: Jibasoft, Inc., Morgan Hill, CA (US)

(72) Inventors: Eric Pansegrau, Morgan Hill, CA (US); Kevin O'Keefe, Gilroy, CA (US)

(21) Appl. No.: 13/915,620

(22) Filed: Jun. 11, 2013

Related U.S. Application Data
(60) Provisional application No. 61/658,331, filed on Jun. 11, 2012.
(60) Provisional application No. 61/764,242, filed on Feb. 13, 2013.

(51) Int. Cl. G09B 7/00

(52) U.S. Cl. CPC G09B 7/00
USPC 434/362

(57) ABSTRACT

Systems for managing sessions and members. The members can include account holders, participants, instructors and session organizers. The system can include account holder data structures, participant data structures and instructor data structures. The account holder data structure can include payment plan and payment information. The account holder data structure can be manipulated to change payment plan and payment information. The participant data structure can include participant information that includes participant skills and expertise. Participant feedback information can be generated for the participant based on the performance of the participant at a session. The participant data structure can be manipulated so that the participant information includes the participant feedback.

### CROSS REFERENCE TO RELATED APPLICATIONS

This application claims priority to U.S. Provisional Patent Application No. 61/764,242, entitled STUDENT MANAGEMENT SYSTEM, filed Feb. 13, 2013, and U.S. Provisional Patent Application No. 61/658,331, entitled STUDENT MANAGEMENT SYSTEM, filed Jun. 11, 2012, both of which are incorporated herein by reference.

### BACKGROUND

As devices become more mobile and faster, applications have been developed that allow tasks to be performed on mobile devices to improve people's lives. Furthermore, applications have been developed to allow business to quickly interact with and perform business with clients through mobile devices that belong to the business or the client. Such applications improve the efficiency of business and allow the businesses to generate more revenue. For example, an application has been developed that allow waiters at a restaurant to take customer orders on a mobile device. The orders are then automatically printed out on a printer in the kitchen, where the meals can be prepared in fulfilling the order. This eliminates the need to worry about whether an order is not legible and creates a common order style that reduces confusion in preparing the orders.

While applications have been developed for devices that extend to nearly all aspects of people's lives and nearly all businesses, there are still business and business types that applications have not been developed in order to improve the efficiency and ease by which the business functions and conducts itself.

Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

Various implementations include systems and methods for managing sessions and members. The members can include account holders, participants, instructors and session organizers. The system and methods can include creating participant data structures, account holder data structures and instructor data structures. In participating in a session, participant feedback for the participant can be generated. The participant data structure can be manipulated to include the participant feedback. The account holder data structure includes payment information and payment plan information. The account holder can submit new payments or choose to utilize a different payment plan. The account holder data structure can be manipulated to include the new payments and reflect the different payment plan that the account holder chooses to utilize.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system configured to manage sessions and members of sessions.

FIG. 2 depicts a diagram of an example of a system configured to manage sessions.

FIG. 3 depicts a diagram of an example of a system configured to manage account holders.

FIG. 4 depicts a diagram of an example of a system configured to manage instructors and instruction of the sessions.

FIG. 5 depicts a diagram of an example of a system configured to manage participants of the sessions.

FIG. 6 depicts a flowchart of an example of a method for creating and managing sessions.

FIG. 7 depicts a flowchart of an example of a method for determining whether an account holder is past due on payment.

FIG. 8 depicts an example session data structure for a session.

FIG. 9 depicts an example account holder data structure for an account holder.

FIG. 10 illustrates an example of a screen depicting an interface through which an account holder or a participant can input participant information related to generating a request for a session.

FIG. 11 illustrates an example of a screen depicting an interface through which a session organizer can view attendance reports and account holders are past due payment.

FIG. 12 illustrates an example of a screen depicting an interface through which a session organizer or an account holder can submit payment information.

FIG. 13 illustrates an example of a screen depicting an interface that includes session information.

FIG. 14 illustrates an example of a screen depicting an interface through which a session organizer or instructor can create new sessions.

FIG. 15 illustrates an example of a screen depicting an interface that displays a report illustrating participant information.

### DETAILED DESCRIPTION

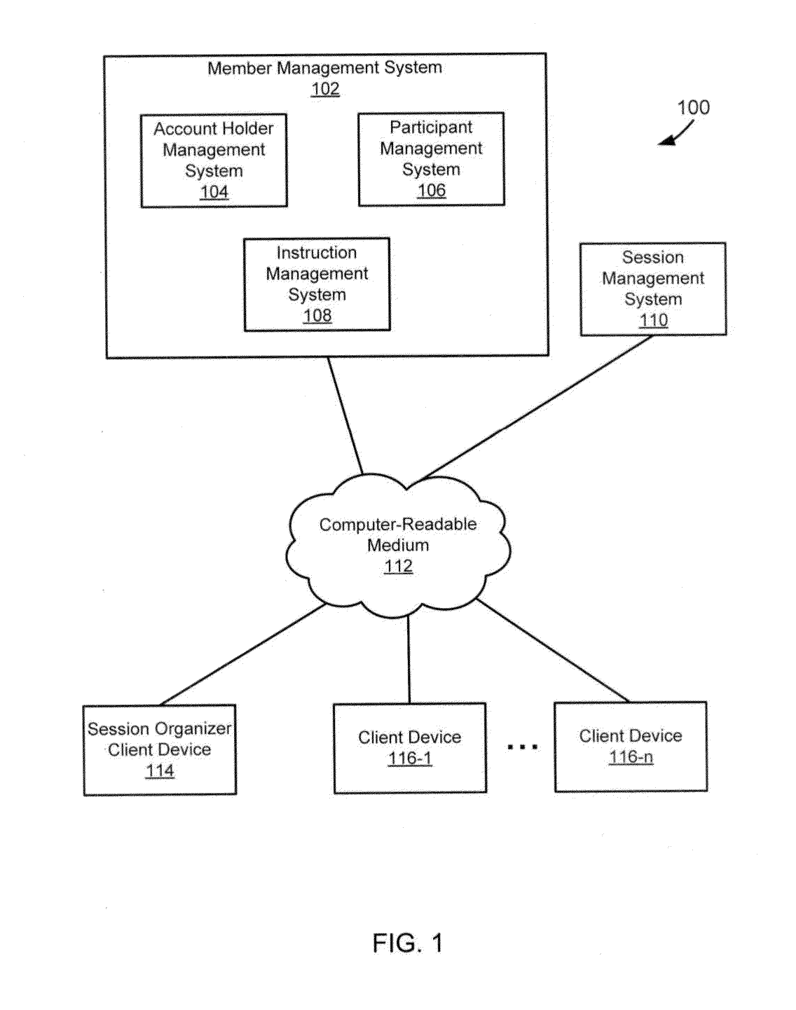

FIG. 1 depicts a diagram 100 of an example of a system configured to manage sessions and members of sessions. The system of the example of FIG. 1 includes a member management system 102, a session management system 110, a session organizer client device 114 and client devices 116-1 . . . 116-n (hereinafter referred to as “client devices 116”). The member management system 102 includes an account holder management system 104, a participant management system 106 and an instruction management system 108. The member management system 102, including the account holder management system 104, the participant management system 106 and the instruction management system 108, as well as the session management system 110, the session organizer client device 114 and the client devices 116 are coupled to a computer-readable medium 112.

As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 112 is intended to represent a variety of potentially applicable technologies. For example, the computer-readable medium 112 can be used to form a network or part of a network. Where two components are co-located on a device, the computer-readable medium 112 can include a bus or other data conduit or plane. Where a first component is co-located on one device and a second component is located on a different device, the computer-readable medium 112 can include a wireless or wired back-end network or LAN. The computer-readable medium 112 can also encompass a relevant portion of a WAN or other network, if applicable.

The member management system 102, the systems included as part of the member management system, the session management system 110, the computer-readable medium 112, the session organizer client device 114, the client devices 116 and any other systems, devices or interfaces described in this paper can be implemented as a computer system or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor transforms data into new data using implemented data structures and methods, such as is described with reference to the FIGs. in this paper.

The engines described in this paper, or the engines through which the systems, devices and interfaces described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

The member management system 102 can perform function related to the management of the members of the sessions and provide access to a session organizer for the purpose of managing the members associated with sessions. The members can include session organizers, account holders, instructors and participants who join or otherwise interact with the sessions. The sessions can be managed by the session organizers, who can interact with and manage the sessions through the session organizer client device 114. The participants are individuals who attend the sessions. The session organizer can also be a participant and attend the sessions. The account holders are individuals or a group of individuals who pay for the right to attend the sessions. An account holder can be a different individual from the participant or the same individual as the participant. Specifically, the account holder can be associated with a participant. In being associated with a participant, the account holder can pay for the right of the participant to attend sessions and act as a participant in a session. For example, the account holder can be a parent and the participant can be the child of the parent. Alternatively, in another example, the account holder can be an adult who attends the session and is therefore also a participant.

In managing the members, the member management system can interact with members including sending data to and receiving data from the members. Specifically, the member management system 102 can create and receive member information. The member information can include any data or information generated or received by the member management system 102 related to members. For example, the member information can include data payment plans of specific members, the payment status of specific members, notifications of due payment for specific members, the identification and skills of instructors, tests to be performed during specific sessions by specific members, participant identification information, and any other information data that is received by or generated by the member management system 102 and the various systems within the member management system 102. As part of managing the members, the member management system 102 can function to send the member information to various members who can either be associated with or have an interest in receiving and viewing the membership data.

The member management system 102 includes an account holder management system 104, a participant management system 106 and an instruction management system. As will be discussed in greater detail later, the account holder management system 104 can function to manage the account holders that are associated with the sessions, the participant management system 106 can function to manage the participants of the sessions, while the instruction management system 108 can function to manage the instructors of the sessions and the tests associated with specific sessions. More specifically, the account holder management system 104 can include account holder data structures that can contain account holder information, the participant management system 106 can include participant data structures that can contain participant information, and the instruction management system 108 can include test data structures that contain test information and instructor data structure that contain instructor information. The account holder data structures, the participant data structures and the instructor data structures can all be classified as member data structures.

The session management system 110 can perform functions related to the management of the sessions and further provide access to a session organizer for the purpose of managing the sessions. A session can be a gathering of members for a common goal. Specifically, a session can be a class for a group of students. For example, a session can be a martial arts instruction class. Alternatively, a session can be a group of people who meet up with a common purpose or interest. For example, a session can be a group of people who meet up to perform a bike ride up a mountain.

In managing sessions, the session management system 110 can generate or include session data structures. A session data structure can represent a single session or a plurality of sessions. The session data structures can contain session information that is either or both generated and received by the session management system. The session information can include any information or data generated or received by the session management system 110 that relates to sessions. More specifically, the session management session can perform any function for generating session information that is stored in the session data structures, including, by way of example, receiving requests for sessions, creating sessions and enrolling participants in sessions. The session information can include what sessions are available and what members are enrolled as participants in each session. Additionally, the session information can include what instructors will be teaching at the session and what the focus or characteristics of the session are. For example, if a session is a dance exercise class, the session information can include that the specific session is a dance exercise class.

Additionally, in managing session, the session management system can send the session information, stored as part of the session data structures, to members. Specifically, the session management system 110 can send a list of sessions of a particular type that are open to a member that has requested to participate in sessions of the particular type. For example, if a member has requested to participate in a dance exercise class, the session management system 110 can send information of the available dance exercise classes to the member.

The client devices 116 and the session organizer client device 114 can be devices through which members can interact with the systems shown in FIG. 1. In interacting with the system, the members can, by way of example, receive member and session information. Additionally, in interacting with the systems shown in FIG. 1, the members can manipulate or create any of the data structures described in this paper if the member has authorization to manipulate or create the data structure in a particular way. Manipulating a data structure can include retrieving data contained in the data structure, changing data contained in the data structure or viewing data contained in the data structure. In one implementation, only a specific account holder can be granted authorization to change an account holder data structure for that specific account holder. In manipulating the data structures members can view scheduled sessions, organize sessions, organize or make payments for sessions, sign up for sessions, make requests for new sessions and schedule instructors for sessions. The members can interact with the systems shown in FIG. 1 on-site at the location of a session. On-site can also include interacting with the system shown in FIG. 1 immediately before the session is going to occur. Specifically, a member can register for a session through the session organizer client device 114 or the client devices 116 at the location of the session.

The account holder data structure in the account holder management system 104 and the participant data structure in the participant management system 106 can be created by an account holder, a session organizer or an instructor through the session organizer client device 114 of any of the client devices 116. The account holder data structure and the participant data structure can be created when an account holder registers themselves and a participant to be a members that use the systems described in this paper. In one example, an account holder can register themselves and the participant at a session through the session organizer client device 114.

The client devices 116 and the session organizer client device 114 each have a media access control address (MAC address). The MAC address serves as a unique identifier that can be used to associate a particular member with a client device. The session management system 110 can store the MAC address with other member identification information. The MAC address can be used, by the session management system 110 and the member management system 102 to route session information and member information to the specific members that use or are associated with the client device to which the MAC address is assigned.

The client device 116, the session organizer client device 114 and any other device described in this paper can be wireless portable devices. In being a wireless portable device, any member can interact with the system on-site at the session. For example, an account holder can make a payment for a session or change their payment plan at the session. Additionally, the account holder can sign up for additionally session at a session.

In the operation of the example system in FIG. 1, the member management system 102, the account holder management system 104, the participant management system 106, the instruction management system 108, the session management system 110, the session organizer client device 114 and the client devices 116 can communicate with each other through the computer readable medium 112. Communicating can include exchanging data, including member information and session information contained within the various data structures, such as the session data structures. More specifically, in the operation of the example system in FIG. 1, the member management system 102 and the session management system 110 can receive data from the session organizer client device 114 and the client devices 116 to create member information and session information. Furthermore, in operation, the member management system 102 can send generated or received member information to the session management system 110, while the session management system can send generated or received session information to the member management system 102.

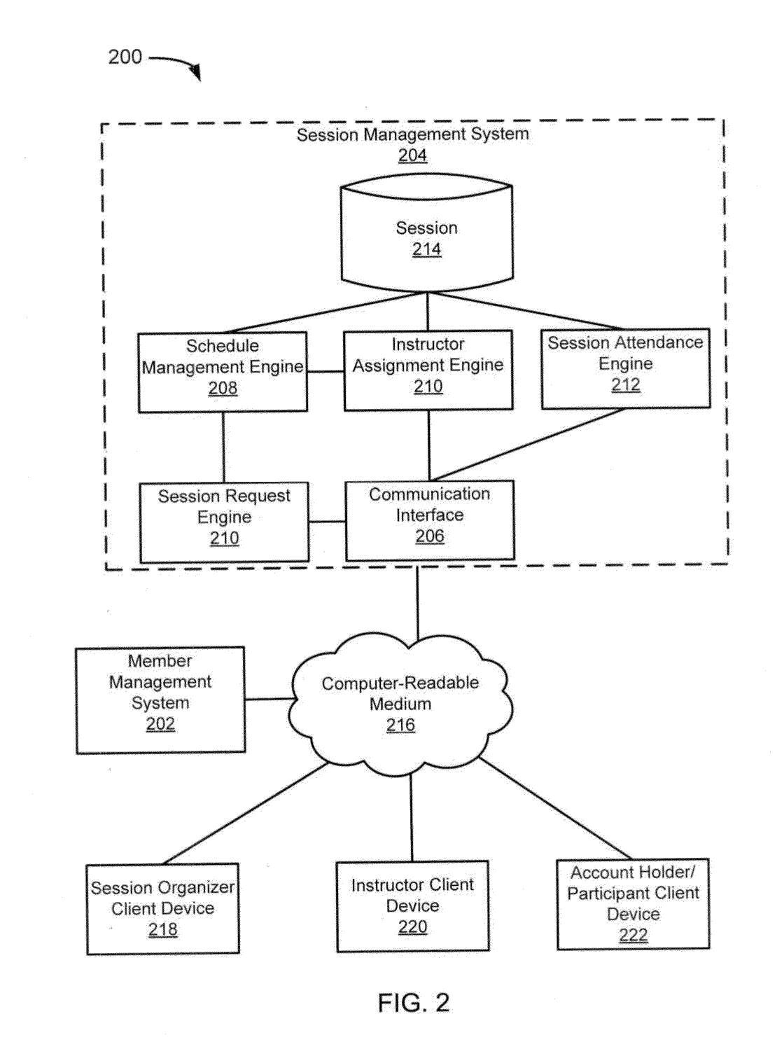

FIG. 2 depicts a diagram 200 of an example of a system configured to manage sessions. In managing session, the system can function to generate and/or manipulate session data structures or allow a member with authorization to generate and/or manipulate session data structure. The example system shown in FIG. 2 includes a member management system 202, a session management system 204, a computer-readable medium 216 a session organizer client device 218, an instructor client device 220, and an account holder/participant client device 222.

The member management system 202, the session management system 204, the session organizer client device 218, the instructor client device 220, and the account holder/participant client device 222 are coupled together through the computer-readable medium 216. The member management system 202 and the session management system 204 can be implemented as and perform the same functions as the member management systems and session management systems described in any of the FIGs. of this paper. As part of manipulating and/or generating session data structure, the member management system 202 and the session management system 204 can send data to and receive data from each other, the session organizer client device 218, the instructor client device 220 and the account holder/participant client device 222.

The instructor client device 220 can be a device that a specific instructor is associated with or uses. The account holder/participant client device 222 can be a device that either a specific account holder or participant, or both an account holder and a participant are associated with or use. For example, the account holder/participant client device 222 can be a device that both a parent, acting as an account holder, and a child, acting as a participant, use.

The session management system includes a communication interface 206, a schedule management engine 208, a session request engine 210, an instructor assignment engine, a session attendance engine 212 and a session datastore 212. As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

The communication interface 206 can function to receive data for the session management system 204. The data can be received from the member management system 202, the session organizer client device 218, the instructor client device 220 and the account holder/participant client device 222 through the computer-readable medium 216. The communication interface 206 can also function to send data from the session management system 204, including data that is generated by the session management system 204, to the member management system 202, the session organizer client device 218, the instructor client device 220 and the account holder/participant client device 222.

In receiving data, the communication interface 206 can receive session requests. The session requests can be sent to the session request engine 210 and any of the devices and systems in the example system shown in FIG. 2, including the session organizer client device 218, the instructor client device 220 and the account holder/participant client device 222. The session requests can be generated by the member management system 202, the session organizer client device 218, the instructor client device 220 and the account holder/participant client device 222. The received session requests can be used to manipulate and/or generate session data structures.

The session request can be a request to attend an existing session. For example, an account holder and/or participant, associated with the account holder/participant client device, can receive a schedule of martial arts classes, generated by the session management system 204 from the session data structures. In response to the schedule of martial arts classes, the account holder and/or participant can send a request to attend one of the classes included in the schedule of martial arts classes. As will be discussed in greater detail later, the session management system 204, upon receipt of the request to attend an existing session, can register the requesting member to attend the session.

Alternatively the session request can be a request to create a new session. The request to create a new session can be sent to the communication interface 206 and subsequently the session request engine 210 from the session organizer client device 218, the instructor client device 220 or the account holder/participant client device 222. The session management system 204 can automatically create the new session from the received request to create a new session. Alternatively, the session management system 204 can generate a request to create a new session from the received request to create a new session that is sent to the session organizer for approval. Upon receipt of authorization, from the session organizer, to create the new session, the session management system 204 can actually create the new session.

Additionally, the session request engine can generate a request to create a new session based on the receipt of a number of requests to create a new session. The session request engine 210 can send the generated request to create a new session to the session organizer client device 218, whereby the session organizer can give approval to create the requested session. Specifically, the session request engine 210 can generate a request to create a new session based on the received requests to create a new session, and send the generated request to create a new session to the session organizer client device 218. The session organizer who is associated with or uses the session organizer client device 218, can receive the request to create a new session and authorize the session management system 204 to create a new session. In creating a new session, the session management system 204 can create a session data structure that corresponds to the newly created session.

For example, a plurality of account holder and/or participants can generate a plurality of requests for a specific martial arts class. The requests for a specific martial arts class can be collected by the session request engine 210, which can then generate a request to create the specific martial arts class. The session request engine 210 can send the request to create the specific martial arts class to the session organizer client device 218, through which the session organizer can give approval to the session management system 204 to create the specific martial arts class. The approval can be sent to the communication interface 206 and collected by the session request engine 210.

The session management system 204 can automatically create a new session without receiving authorization from the session organizer. In creating a new session without receiving authorization from the session organizer, the session management system 204 can create a session data structure that corresponds to the new session. The session management session 204 can create a new session immediately after receipt of any number of requests to create a new session. Additionally, the session management system 204 can be configured to create a new session after a certain number of requests for the new session are collected by the session request engine 210. In creating the new session after a certain number of requests are collected by the session request engine 210, the session management system 204 can create the session after a create session threshold is met or exceeded. The create session threshold can be a number of requests to create a session that have to be received before the session management system 204 creates a new session. For example, the session management system 204 can be configured to create a new martial arts class after the session request engine 210 collects five requests to create the new martial arts class. The create session threshold can be set by a member, including the session organizer The create session threshold can be uniquely associated with a specific type of session. For example, the create session threshold can be set higher for one type of session than the create session threshold for another type of session.

Furthermore, the session management system 204 can create a new session if the session request engine 210 receives any number of requests to attend an existing session that is full or otherwise does not have open space available to accommodate a participant. In creating a new session after receiving any number of requests to attend an existing session that is full, the session management system 204 can create a session data structure that corresponds to the new session. Specifically, the session management system 204 can create a new session if the number of requests to attend a session that is full exceeds or is equal to a create session threshold for the specific session. The session management system 204 can use session data to determine that a session is full, and automatically create a new session once a certain number of requests for a session that is full are received. The certain number of requests can range from one to any number of received requests. Alternatively, the session management system 204 can use session data to determine that a session is full, and generate a request to create a new session that can be sent to the session organizer for approval. The session management system 204 can create the new session if authorization is obtained from the session organizer.

The communication interface 206, and any other communication interface described in this paper can also be configured to route and traffic messages between different members. Therefore, the example system of FIG. 2 and any of the other example systems described in this paper, can function as a social network through which members can communicate with each other. In one example, an account holder/participant can send a message or an invitation to another account holder/participant regarding attendance to a specific session. In response to the message or invitation, the account holder/participant to whom the message was sent can generate and send a session request to attend the session that is sent to the session management system 204.

The session request engine 210 is coupled to the schedule management engine 208. The schedule management engine can perform any function related to the creation and scheduling of sessions and members attendance to the sessions. Specifically, the schedule management engine 208 can function to create sessions and register members to attend existing or new sessions based on the requests received by the session request engine 210 according to any of the methods described in this paper. In creating a new session, the schedule management engine 208 can generate a session data structure corresponding the new session. Additionally, in creating a new session, the schedule management engine 208 can register the members who requested to attend the new session or a full session. Registering a member to attend a session can include reserving a spot for the members in the requested session and associating the identification of the members to the reserved spot in the requested session. In registering a member, the schedule management engine 208 can manipulate the session data structure for the session to which the member is being registered. Specifically, the schedule management engine 208 can change the session data structure to include the identification information of the member that is registered to attend the session. The identification information of the members can be obtained by the session management system 204 from identification information contained within the member data structures included as part of the member management system 202.

Alternatively if the session request received by the session request engine 210 is for an existing session, the schedule management engine 208 can function to register the requesting member in the existing session. Similar to registering a member for a new session, in registering a member in the existing session, the schedule management engine 208 can manipulate the session data structure for the existing session. In manipulating the session data structure for the existing session, the schedule management engine 208 can change the session data structure for the existing structure to include the identification information of the member that is registered to attend the existing session.

The schedule management engine 208 is coupled to the session datastore 214 and can store session data structures for the sessions, including newly created sessions, on the session datastore 214. The session data structures can contain session information that can include the identification of the session including the type of session, the location that the session will be held, the time that the session will be held and the identification of the members registered to attend the session. The session information can also include the characteristics of the session, including what tests or pretest qualifications, if any, will be administered at the session.

In creating session data structures for new sessions, the schedule management engine 208 can use the session information contained in the session data structures of existing sessions stored in the session datastore 214, to at least in part, schedule the new sessions. In scheduling a new session, the schedule management engine 208 can determine the time that the new session will be held and the location where the new session will be held. Specifically, the schedule management engine 208 can use the location that the existing sessions will be held, the time that the existing sessions will be held and the members that are attending the existing session, to schedule a new session. In particular, the schedule management engine 208 can schedule new sessions, so that either sessions of the same type, at the same location, or with the same participants do not overlap, or the overlap is minimal. Overlapping can include, whether the sessions are held at the same time, whether the sessions are held at the same location, or whether the sessions include some or all of the same participants. For example, if the schedule management engine 208 is creating a new session that is a class for a specific type of martial art to the same participants, the schedule management engine 208 can schedule the new session so that it does not overlap with an already existing session that is a class for the same specific type of martial art with the same participants.

The schedule management engine 208 can also function to deregister a member from a session. Specifically, the session request engine 210 can receive a request to cancel the registration of a member that is registered to attend a session. In deregistering a member, the schedule management engine 208 can manipulate the session data structure for the session for which the member is deregistering to reflect that the member is no longer registered to attend the session. In manipulating the session data structure, the schedule management engine 208 can change the data structure to reflect that the member is no longer registered and that the spot that was taken is now available for another member to take. Specifically, the schedule management engine 208 can delete the identification information of the member who is being deregistered to. The request to cancel the registration of a member can be generated by and received from the member themselves. Alternatively, the request to cancel the registration of a member can be generated by and received form the member management system 202 or the session organizer. For example, the member management system 202 or the session organizer can generate the request to cancel the registration of a member, if the account holder associated with the member falls behind in payments according to a payment plan or fails to pay for the session.

The schedule management engine 208 can also function to cancel any number of existing sessions. In cancelling any number of sessions the schedule management engine 208 can manipulate the session data structures for the cancelled sessions. In manipulating the session data structures for the cancelled sessions, the schedule management engine 208 can delete the data structures. Specifically, the session request engine 210 can receive a request to cancel an existing session or a plurality of existing sessions. The request to cancel an existing session or a plurality of existing sessions can be generated by and received from a member who has authorization to cancel sessions. For example, the request to cancel an existing session can be generated by and received from the session organizer through the session organizer client device 216. The session management system 204 can generate notifications that a session has been canceled if the session has been canceled. The session management system 204 can send the notification to the members that are associated with the session, including the participants and instructors of the session. The session management system 204 can determine which members are associated with the session based on information contained with the session data structure for the cancelled session.

The instructor assignment engine 210 can function to assign an instructor to a session. In assigning an instructor to a session, the instructor assignment engine 210 can use the session information contained within the session data structures for either an existing session or a new session, to which the instructor assignment engine 210 is assigning an instructor. Further, in assigning an instructor to a session, the instructor assignment engine 210 can use instructor information contained in instructor data structures in the member management system 202 or retrieved from the instructor client device 220. As will be discussed in greater detail later, the instructor information, that is part of the member information, can include the skills or expertise of an instructor and the identification of an instructor. For example, if the specific instructor is skilled in teaching a certain type of martial art, the instructor assignment engine can assign the specific instructor to sessions that are related to the certain type of martial art in which the instructor is skilled. The instructor assignment engine 210 can determine that sessions are related to the certain type of martial art based on the session information in the session datastore 214 that includes the identification of the session.

The instructor assignment engine 210 can manipulate the session data structure to include the instructor information contained within the instructor data structure for the instructor that is assigned to a particular session. Furthermore, the instructor assignment engine 210 can, in part, function to notify the instructor that they have been assigned to a specific session. Specifically, the instructor assignment engine 210 can generate an instructor assignment notification that is sent to the instructor client device 220, through the communication interface 206. In one example, the instructor assignment notification can include an option for the instructor assigned to the session to deny assignment to the session. The instructor assignment notification can be sent back to the communication interface 206 and subsequently the instructor assignment engine 210 from the instructor client device 220. The instructor assignment notification that is sent back from the instructor client device 220 can include whether the instructor has accepted their assignment to the session. If the instructor chooses to not accept the assignment, the instructor assignment engine 210 can assign another instructor to the session. This process can continue until the instructor assignment engine 210 receives a notification from an assigned instructor indicating that the assigned instructor has accepted the assignment.

In creating new sessions and assigning an instructor to a session, the schedule management engine 208 and the instructor assignment engine 210, can function together in both creating new sessions and assigned instructors to sessions. For example, in scheduling a session, the schedule management engine 208 can schedule the session based on the instructor that is assigned to the session by the instructor assignment engine 210. Specifically, the schedule management engine 208 can use the identification of the instructor, that can be included in the session data structures, to determine what sessions an instructor is assigned to and create a schedule of the instructor. The schedule management engine 208 can then schedule the session based on the schedule of the instructor assigned to the session. For example, the schedule management engine 208 can determine that an instructor has a conflict outside of participating at another session that prevents them from participating at the particular session to which they were assigned at specific times or specific locations. The schedule management engine 208 can use the schedule of the assigned instructor to schedule the session, so that the assigned instructor can actually be a participant in the session to which they were assigned.

Similarly, in assigning an instructor to a session, the instructor assignment engine 210 can use the session information contained in the session data structure for a schedule to assign an instructor to the session. For example, in assigning an instructor, the instructor assignment engine 210 can use the location information of the session or the time of the session that is included as part of the session information, to assign an instructor who is able to be a participant in the session. In assigning an instructor, the instructor assignment engine 210 can retrieve instructor information about the instructor from either or both the instructor data structures in the member management system 202 and the instructor client device 220. The instructor information retrieved from either or both the instructor data structures and the instructor client device 220 can be used by the instructor assignment engine, along with location information of the session or the time of the session to assign the instructor. For example, if an instructor is located in a different city at the time that a session is scheduled, or otherwise has a personal conflict that prevents them from participating in a session based upon the schedule of the session, the instructor assignment engine 210 can assign a different instructor to be a participant in the session.

The session attendance engine 212 can function to manage and generate attendance records for occurred sessions. The session attendance engine 212 can collect attendance data that is received by the communication interface 206 from the member management system 202, the session organizer client device 218, the instructor client device 220 and the account holder/participant client device. The attendance data can be included as part of the session information and can include the identification of the members who attended or acted as participants in a session. In managing the attendance, the session attendance engine 212 can manipulate the session data structure to include attendance data in the session data structure. The attendance data can include which participants were present at the occurred session. For example, if the session is a martial arts class, the attendance data can include the identification of all participants in the martial art class and the instructor or instructors of the martial art class. The attendance data that is included as part of the session data structure, can be used to generate attendance records. The attendance records can be included as part of member data structures for specific members and can be used, by the member management system 202 to generate payments for account holders.

In the operation of the example system in FIG. 2, the member management system 202, the session management system 204, the session organizer client device 218, the instructor client device 220 and the account holder/participant client device 222 can communicate with each other through the computer readable medium 216. Communicating can include exchanging data, including member information, session information, session request notifications and instructor assignment notifications. The session management system 204 can send and receive data through the communication interface 206.

More specifically, in the operation of the session management system 204 of the example system in FIG. 2, the session request engine 210 can collect requests for sessions that are received by the communication interface 206. The requests for sessions can include requests for existing sessions or new sessions. The schedule management engine 208 can use the received requests to create session data structures for newly created sessions or existing sessions that can be stored on the session datastore 214. The session data structures can include session information. The schedule management engine 208 can also register members to attend sessions and update the session data structures to reflect the registration of the member to attend the session. The instructor assignment engine 210 can assign instructors to attend the sessions. The instructor assignment engine 210 can use session information in the session data structures stored in the session datastore 214. Similarly, the schedule management engine can use the instructor assignment engine 210 and data stored in the session datastore 214 to schedule sessions. Furthermore, in the operation of the session management system 204 of the example system in FIG. 2, the session attendance engine 212 can function to collect attendance data of completed sessions and manipulate the session data structures to include attendance data as part of the session information contained within the session data structures. Additionally, the session attendance engine 212 can generate attendance records for members that can be used by the member manage system and any other device in the example system of FIG. 2.

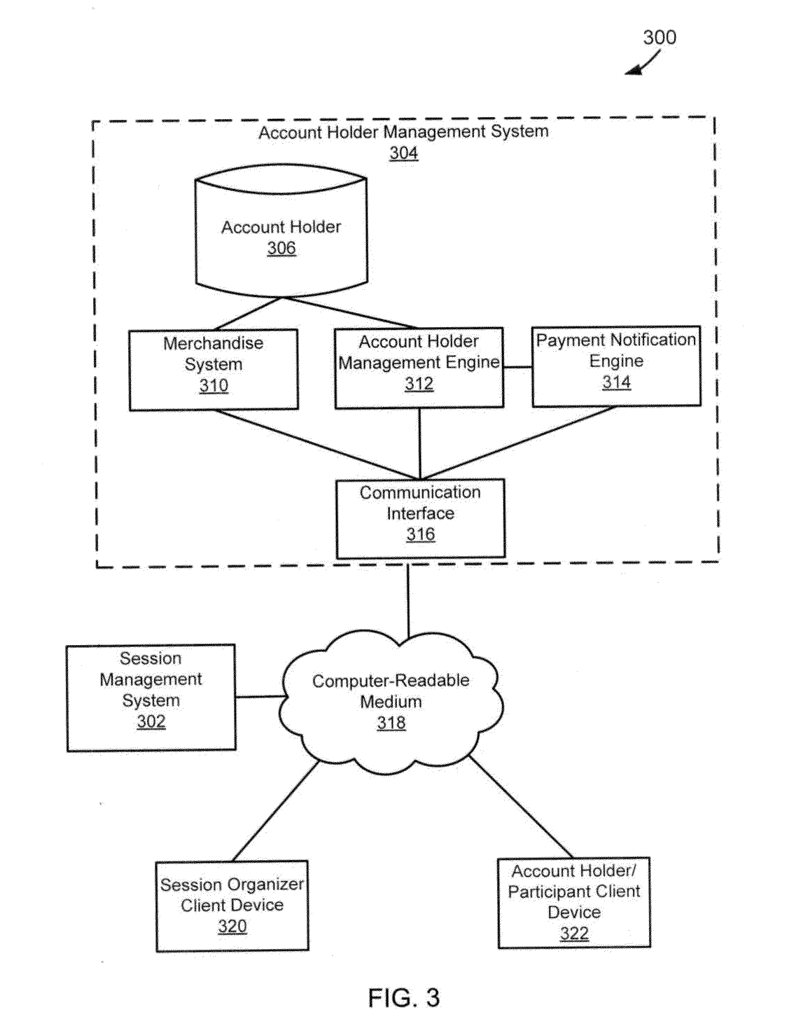

FIG. 3 depicts a diagram 300 of an example of a system configured to manage account holders. The example system shown in FIG. 3 includes a session management system 302, an account holder management system 304, a computer-readable medium 318, a session organizer client device 320 and an account holder/participant client device 322. As discussed with respect to FIG. 2, the account holder can also be a participant, therefore the account holder/participant client device 322 can be the device which an account holder and/or a participant are associated with or use.

The session management system 302, the account holder management system 304, the session organizer client device 320 and the account holder/participant client device 322 are coupled together through the computer-readable medium 310. The session management system 302, the session organizer client device 320 and the account holder/participant client device 322 can be implemented as and perform the same functions as any session management system, session organizer client device and account holder/participant client device described in any of the FIGs. of this paper. Further, the account holder management system 304, the session management system 302, the session organizer client device 320 and the account holder/participant client device 322 can communicate with each other, including sending and receiving data between each other.

The account holder management system 304 includes a communication interface 316, a merchandise system 310, an account holder management engine 312, a payment notification engine 314 and an account holder datastore 306.

The communication interface 316 can function to receive data for the account holder management system 304. The data can be received from the session management system 302, the session organizer client device 320, the account holder/participant client device 322, the instruction management systems described in any of the FIGs. of this paper and the participant management systems described in any of the FIGs. of this paper through the computer-readable medium 318. The communication interface 316 can also function to send data from the account holder management system 304, including data that is generated by the account holder management system 304, to the session management system 302, the session organizer client device 320, the account holder/participant client device 322, the instruction management systems described in any of the FIGs. of this paper and the participant management systems described in any of the FIGs. of this paper through the computer-readable medium 318.

The account holder management engine 312 can collect or receive from the communication interface 316 account holder information. The account holder management engine 312 can use the account holder information to create and manipulate account holder data structures stored in the account holder datastore 306. The account holder data structures can be unique to each account holder, so that every account holder has at least one data structure that is unique to them. The account holder information can be sent to the account holder management system 304 from the session organizer client device 320 and the account holder/participant client device 322. The account holder information can include identification information of the account holder. The identification information can include billing information of the account holder, the participants, if any, associated with the account holder and contact information of the account holder. The identification information can also include a photograph of the account holder.

The account holder information can also include the identification information of participants of which an account holder is associated. The account holder can be associated with specific sessions if they are responsible for paying for the participant to attend the sessions. The account holder management engine can receive the identification of the participants that the account holder is associated with from the account holder or the session organizer. The account holder management engine 312 can manipulate the account holder data structure to include the identification information of the participants.

The account holder information can also include payment plan information for a specific account holder. The payment plan information can include the amount of each payment, the schedule of when the payments are supposed to be made and the number of sessions that a participant associated with the account holder or the account holder themselves are allowed to attend. For example, the payment plan can be a monthly payment schedule, that allows an account holder or a participant associated with the account holder to attend two sessions per month. In another example, the payment plan can be a monthly payment schedule that allows an account holder or a participant associated with the account holder to attend unlimited sessions per month. The payment plan information can be received through the communication interface 316 and collected by the account holder management engine 312. The account holder management engine 312 can manipulate the account holder data structures to include the payment plan information for thee account holder.

The payment plan can be changed after it is set. Specifically, a member, including the session organizer or the account holder can send new payment plan information to the account holder management system 304. The account holder management engine 312 can receive the new payment plan data and manipulate the account holder data structure to include the new payment plan data. Therefore the account holder data structure can include the new payment plan of an account holder.

Additionally, the account holder management system 304 can receive and generate payment information that is included as part of the account holder information. Specifically, the communication interface 316 can receive account holder information that includes payment information. The payment information can be received from the session organizer client device 320 and the account holder/participant client device 322. Additionally, the received payment information can include data that can be used to complete a payment transaction. For example, the payment information can include a credit card number or a bank account number and routing number of an account holder. In one example, the payment information can be received by a session organizer on the session organizer client device 320 at a session that the account holder or a participant associated with the account holder is attending. Additionally, the payment information can include data related to a payment made by the account holder. For example, if the account holder pays in cash on-site at a session, the payment information can reflect the payment made by the account holder on-site. The data related to a payment made by the account holder, can include the number of sessions for which the account holder has paid. For example, if the account holder pays for multiple sessions, the data related to a payment made by the account holder, can include the number of sessions for which the account holder has paid. The generated payment information can include that an account holder has never made a payment, if the account holder has never made a payment.

The account holder management engine 312 can manipulate the account holder data structure to include the generated and received payment information for the specific account holder. As the payment data information includes the transactions for a specific account holder, the payment information can form a transaction history for the account holder.

The account holder data structure, can be securely protected using a password or some other form of data security. Specifically, the communication interface can be configured to allows access to the account holder data structure by an account holder or other member when the member trying to access the account holder data structure has input the correct password. The password can be included as part of the account holder information in the account holder data structure. The account holder management engine 312 can also be configured to allow an account holder to change their password. Specifically, the account holder management engine can verify that the account holder is requesting to change their password, and receive the new password of the account holder form the communication interface 316. The account holder management engine 312 can manipulate the account holder data structure to include the new password.

As the session organizer client device 320 and the account holder/participant client device can be portable devices, the session organizer and the account holder can manipulate the account holder data structure from anywhere, including at the session. For example, an account holder can make a payment by submitting payment information or change the payment plan at the site of the session after interacting with an instructor or the session organizer. Specifically, a parent can drop their child off to a martial art session and quickly make a payment for the session or modify their payment plan to cover payment for the session.

The payment notification engine 314 can function to generate notifications of payments. The notification can be of a payment that is received or a payment that is due. The payment notification engine 314 can use the account holder information in the account holder data structures stored in the account holder datastore 306 to generate notifications of payments. For example, the payment notification engine 314 can receive payment information, payment plan information and identification information of the account holder from the account holder data structures to generate a payment notification that a payment is due. In determining that a payment is due, the payment notification engine 314 can compare the payment information to determine whether an account holder is past due in payment.

Furthermore, in determining that a payment is due, the payment notification engine 314 can also use session information stored in the session data structures. In particular, the payment notification engine 314 can compare the session information along with the payment plan information and the payment information to determine whether an account holder is past due in payment. Specifically, the payment notification engine 314 can use the attendance data that is included as part of the session information in to determine the number of sessions that an account holder or a participant associated with the account holder is registered for or has attended. For example, if an account holder is under a payment plan that allows for them or a participant associated with them to attend two sessions a month, and the payment notification engine 314 determines from the attendance data that the account holder or a participant with an account holder has attended more than two sessions in a month, then the payment notification engine can determine that the account holder is past due.

The payment notification engine 314 can use the identification information of the account holder in the account holder data structure to determine the identification and contact information of the account holder, and include the account holder identification information in the notification. The payment notification engine 314 can send the payment notification to the session organizer client device 320. Additionally, the payment notification engine 314 can use the identification of the account holder to identify the account holder/participant client device 322 and send the notification to the account holder/participant client device 322.

The payment notification engine 314 can be configured to send the payment notifications for past due payments to the session organizer before the payment notifications are sent to the account holder. Specifically, the payment notifications can require approval from the session organizer before being sent to the account holder. The session organizer can choose to not give authorization to send the payment notification informing that the account holder is past due in payment. As a result, the notification can be stored as part of the account holder information but not actually be sent to the account holder.

Furthermore, the account holder management engine 312 can use the payment notification generated by the payment notification engine 314 to manipulate the account holder data structure to include generated and or sent payment notifications. The payment notification can reflect that an account holder is past due in payment and can remain in the account holder data structure until the account holder becomes current on payment. For example, the account holder management engine 312 can delete the payment notification from the account holder data structure when the account holder becomes current on payment. Alternatively, the account holder management engine 312, instead of deleting the payment notification, can flag the payment notification that is included in the account holder data structure as obsolete, when the account holder becomes current on payment.

The merchandise system 310 can function to provide merchandise or session deals to the account holder. Specifically, the merchandise system 310 can generate merchandise or deal notifications that can be sent to a specific account holder. The merchandise notification can include sales of specific merchandise that are related to a session. The deal notification can include a deal on particular sessions, such as a discount on attending a particular session. The merchandise system 310 can determine what account holder to generate the merchandise and deal notifications for and what account holder to send the merchandise and deal notification to based on the account holder data structure. Specifically, the merchandise system 310 can generate and send the merchandise and deal notifications based on the account holder information of the account holder.

For example, if the account holder information indicates that an account holder or a participant associated with an account holder is attending sessions of a particular type of martial art, the merchandise system 310 can generate and send merchandise notifications to the account holder for merchandise that is related to or used in the sessions of the particular type of martial art. Similarly, the identification information of the account holder indicates that an account holder or a participant associated with an account holder is attending session of a particular type of martial art, the merchandise system 310 can generate and send deal notifications to the account holder for sessions of the particular type of martial art or other martial art type sessions that are related to the particular type of martial art.

In the operation of the example system in FIG. 3, the session management system 302, the account holder management system 304, the session organizer client device 320 and the account holder/participant client device 322 can communicate with each other through the computer readable medium 318. Communicating can include exchanging account holder information. The account holder management system 304 can receive and send data through the communication interface 316.

More specifically, in the operation of the example system in FIG. 3, the account holder management system 304 can receive session information related to specific account holders from the session data structures in the session management system 302. The session information can be included as part of the account holder information in the account holder data structure. Additionally, the account holder management system 304 can receive account holder information from the session organizer or the account holder through either or both the session organizer client device 320 or the account holder/participant client device 322. The account holder management engine 312 can manipulate the account holder data structure to include the received account holder information. The account holder information can include payment information, payment plan information for the account holder and the participants associated with the account holder.

In operation, the payment notification engine can use the information in the account holder data structure, including the account holder information, to generate payment notifications. The payment notification can identify a successful payment transaction, or that payment is due from an account holder. The payment notification engine 314 can send the payment notifications to either or both the session organizer client device 320 or the account holder/participant client device 322. Further, in operation, the merchandise system can use the information in the account holder data structure, including the account holder information, to generate and send merchandise or deal notifications. The merchandise or deal notifications can be sent to the account holder/participant client device 322, to inform the account holder of the merchandise for sale or the deals on sessions.

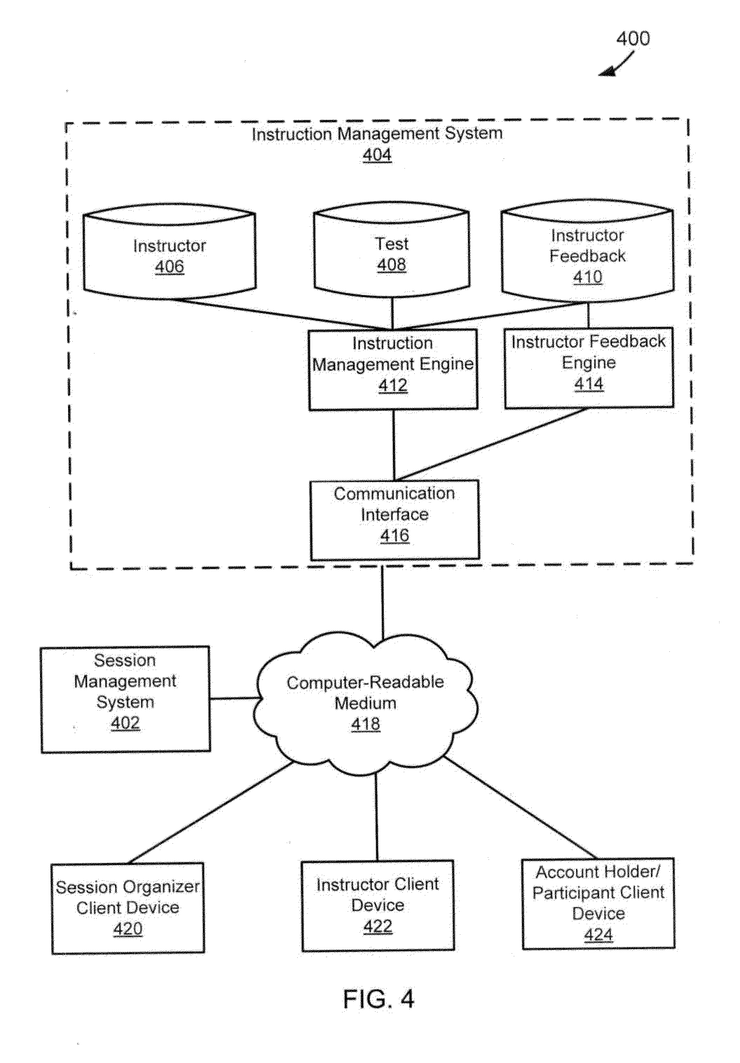

FIG. 4 depicts a diagram 400 of an example of a system configured to manage instructors and instruction of the sessions. The example system shown in FIG. 4 includes a session management system 402, an instruction management system 404, a computer-readable medium 418, a session organizer client device 420, an instructor client device 422 and an account holder/participant client device 424. As discussed with respect to FIGS. 2 and 3, the account holder can also be a participant, therefore the account holder/participant client device 424 can be the device which an account holder and/or a participant are associated with or use.

The session management system 402, the instruction management system 404, the session organizer client device 420, the instructor client device 422 and the account holder/participant client device 424 are coupled together through the computer-readable medium 418. The session management system 402, the session organizer client device 420, the instructor client device 422 and the account holder/participant client device 424 can be implemented as and perform the same functions as any session management system, session organizer client device, instructor client device and account holder/participant client device described in any of the FIGs. of this paper. Further, the instruction management system 404, the session management system 402, the session organizer client device 420, the instructor client device 422 and the account holder/participant client device 424 can communicate with each other, including sending and receiving data between each other through the computer-readable medium 418.

The instruction management system 404 includes an instructor datastore 406, a test datastore 408, an instructor feedback datastore 410, an instruction management engine 412, an instructor feedback engine 414 and a communication interface 416.

The communication interface 416 can function to receive data for the instruction management system 404. The data can be received from the session management system 402, the session organizer client device 420, the instructor client device 422, the account holder/participant client device 424, the account holder management systems described in any of the FIGs. of this paper and the participant management systems described in any of the FIGs. of this paper through the computer-readable medium 418. The communication interface 416 can also function to send data from the instruction management system 404, including data that is generated by the instruction management system 404, to the session management system 402, the session organizer client device 420, the instructor client device 422, the account holder/participant client device 424, the account holder management systems described in any of the FIGs. of this paper and the participant management systems described in any of the FIGs. of this paper through the computer-readable medium 418.

The instructor datastore 406 can include instructor data structures. The instructor data structures can be created by an instructor or a session organizer through the instruction management engine 412. The instructor data structure can be created whenever an instructor is registered as a member. For example, an instructor can be registered as a member when they are hired to be an instructor at sessions.

The communication interface 416 can receive instruction information that includes instructor information. The instruction management engine 412 can collect the instructor information and manipulate the instructor data structure to include the instructor information. The instructor information can include identification information of the instructor including the contact details of a specific instructor, the name of the specific instructor and a picture of the specific instructor The instructor information can also include the skills and expertise of the specific instructor. The skills and expertise of the specific instructor can include what session the instructor has taught, and any other skills or expertise of the instructor. For example, if the instructor is skilled in a specific type of martial art, the instructor information can include that the instructor is skilled in the specific type of martial art. Additionally, if the skill and expertise is in an area that has a leveled performance measurement system, the instructor information can include what level within the performance measurement system for the skill and expertise that the instructor has achieved. For example, if the skill and expertise is in a martial art that has a belt level system, the instructor information can include what belt, e.g. “black belt”, that the instructor has obtained. The instructor information can also include any information identifying certifications that an instructor has obtained. For example, if the instructor is certified in CPR, the instructor information can include that the instructor is CPR certified.

The instructor and the session organizer can manipulate the instructor data structure, through the instruction management engine 412, by sending instructor information, as part of instruction information, to the instruction management system 404. For example, if an instructor has obtained a new certification, the instructor and the session organizer can send instructor information that reflects the obtained certification.

The test datastore 408 can include test data structures. The test data structures can be created by an instructor or a session organizer through the instruction management engine 412. The test data structure can be created whenever a new test is created. The instruction information received by the communication interface can also include test information. The test information can also include qualifications that need to be achieved or passed before the test can be administered to a participant. The instruction management engine 412 can manipulate the test data structure to include the test information. The test information can include identification and steps that need to be administered and performed within a test. The test information can also include the rules for the test that are used to determine whether or not a participant has passed the test. The rules can include the minimum scores that a participant needs to achieve in order to pass the test. Additionally, the test can be used as an assessment in determining whether a participant has obtained a certain level within the subject matter that is taught in a particular session or any number of related sessions. For example, if the session is a specific type of martial art, the test can be the moves that a participant needs to accomplish in order to obtain a belt level in the type of martial art.

The test information can be generated by an instructor or a session organizer and sent to the instruction management system 404 from the session organizer client device 420 and the instructor client device 422. The test data structure including the test information within the test data structure can be sent to the instructor client device 422 based on the session for which the instructor that is associated with or uses the instructor client device 422 is assigned. For example, if an instructor is assigned to teach a specific type of martial art class, the instruction management system 404 can send the test data structure related to the specific martial art class to the instructor. The test can be presented as a plurality of fields in a graphical user interface for each step in the test, that the instructor can then populate with either a passing or failing score as the test is being administered during the session. The populated fields for the test can be sent to the participant management system, as will be discussed in greater detail later, as participant feedback.

The instruction information received by the communication interface 416 can also include instructor feedback. The instructor feedback can be collected by the instructor feedback engine 414 and stored in the instructor feedback datastore 410. The instructor feedback can include evaluations and reviews of specific instructors. The instructor feedback can be received from the session organizer client device 420 and the account holder/participant client device 424. The instructor feedback engine 414 can be configured to generate an instructor evaluation report based on the instructor feedback that can be sent to the session organizer or the instructor themselves. Furthermore, the instruction management engine 412 can use the instructor feedback to manipulate the instructor data structure to include the instructor feed back

In the operation of the example system in FIG. 4, the session management system 402, the instruction management system 404, the session organizer client device 420, the instructor client device 422 and the account holder/participant client device 424 can communicate with each other through the computer readable medium 418. Communicating can include exchanging instruction data. The instruction management system 404 can receive and send data through the communication interface 416.

More specifically, in the operation of the example system in FIG. 4, the instruction management system 404 can receive instructor information, test information and instructor feedback as part of instruction information. The instruction management engine 412 can generate and manipulate instructor data structures and test data structures that include the instructor information, the test information and the instructor feedback. The test data structure can be sent to the instructor to be used in administering tests during a session to which an instructor is assigned. The instruction management engine 412 can generate evaluation reports for the instructors based on the instructor feedback stored in the instructor feedback datastore 410.

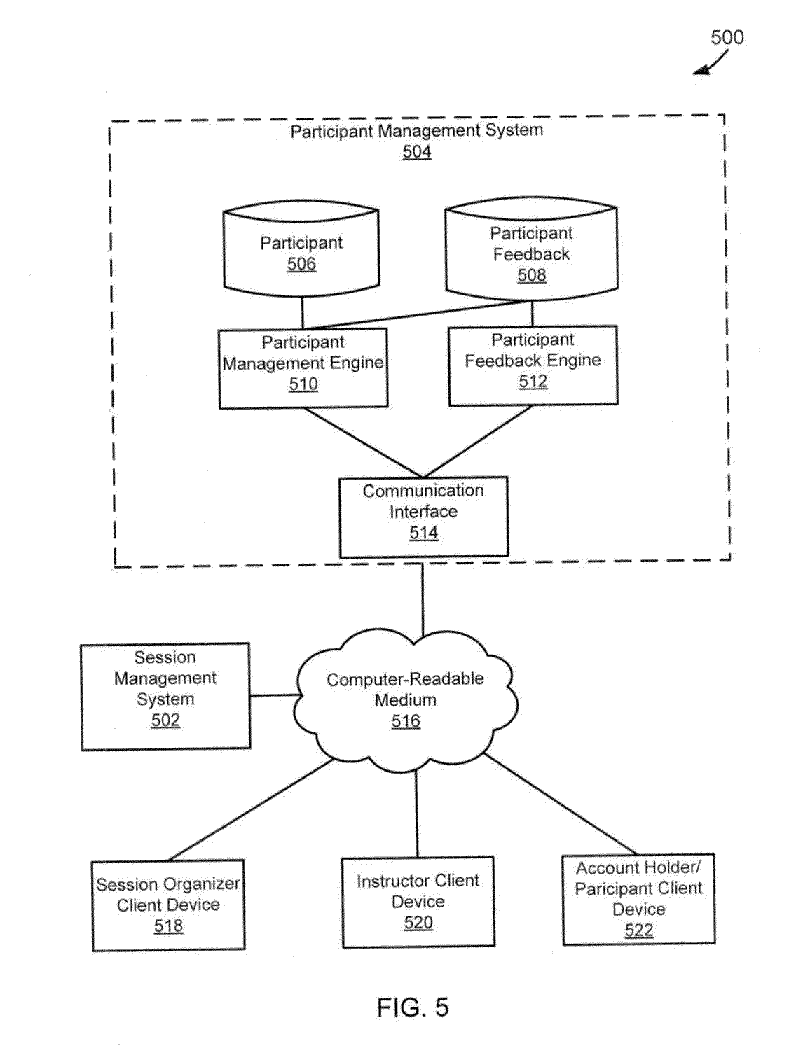

FIG. 5 depicts a diagram 500 of an example of a system configured to manage participants of the sessions. The example system shown in FIG. 5 includes a session management system 502, a participant management system 504, a computer-readable medium 516, a session organizer client device 518, an instructor client device 520 and an account holder/participant client device 522. As discussed with respect to FIGS. 2-4, the account holder can also be a participant, therefore the account holder/participant client device 522 can be the device which an account holder and/or a participant are associated with or use.

The session management system 502, the participant management system 504, the session organizer client device 518, the instructor client device 520 and the account holder/participant client device 522 are coupled together through the computer-readable medium 516. The session management system 502, the session organizer client device 518, the instructor client device 520 and the account holder/participant client device 522 can be implemented as and perform the same functions as any session management system, session organizer client device, instructor client device and account holder/participant client device described in any of the FIGs. of this paper. Further, the participant management system 504, the session management system 502, the session organizer client device 518, the instructor client device 520 and the account holder/participant client device 522 can communicate with each other, including sending and receiving data between each other through the computer-readable medium 516.

The participant management system 504 includes a participant datastore 506, a participant feedback datastore 508, a participant management engine 510, a participant feedback engine 512 and a communication interface 514.

The communication interface 514 can function to receive data for the participant management system 504. The data can be received from the session management system 502, the session organizer client device 518, the instructor client device 520, the account holder/participant client device 522, the account holder management systems described in any of the FIGs. of this paper and the instruction management systems described in any of the FIGs. of this paper through the computer-readable medium 516. The communication interface 514 can also function to send data from the participant management system 504, including data that is generated by the participant management system 504, to the session management system 502, the session organizer client device 518, the instructor client device 520, the account holder/participant client device 522, the account holder management systems described in any of the FIGs. of this paper and the instruction management systems described in any of the FIGs. of this paper through the computer-readable medium 516.

Participant data structures can be stored in the participant datastore 506. The participant data structures can be unique to participants so each participant is uniquely represented by at least one participant data structure. Participant data structures can be created when a participant is registered as a member the system. The participant can be registered when the account holder associated with the participant registers as a member. The session organizer, the instructor or the account holder can control creation of the participant data structures.

The communication interface 514 can receive participant information. The participant management engine 510 can collect the participant information of the participant received by the communication interface 514 and manipulate the participant data structure in the participant datastore 506 to include the participant information. The participant information can include identification information of the participant. The identification information of the participant can include the contact information of the participant, the identity of the participant and a picture of the participant. The identification information of the participant can be generated by and sent from the session organizer client device 518, the instructor client device 520 and the account holder/participant client device 522. The identification information can also include emergency contact information for the participant, including a person or an entity to contact in the event of an emergency. For example, if the participant if a child, the emergency contact information can be a parent of the child.

The participant information can also include the skills and expertise information of the participant. Specifically the skills and expertise of the participant can include whether a participant has talent or experience in the subject matter of a certain session or group of related sessions. The subject matter of a certain session or group of related sessions can include a specific type of martial art. Additionally, the skills and expertise information can include what tests a participant has passed. The skills and expertise of the participant can include what level the participant has achieved in the subject matter of a certain session or group of related sessions, if the subject matter uses a leveled performance measuring system. For example, the skills and expertise information can include that a participant has a achieved a specific belt level in a specific type of martial art.

The participant information, including the skills and expertise information of the participant, in the participant data structure can be used by the account holder management systems described in the FIGs. of this paper to send merchandise and deal notifications to the account holders. Furthermore, participant information, including the skills and expertise information of the participant, in the participant data structure can be used by the session management system 502 to generate lists of available session that an account holder or a participant associated with the account holder might be interested in registering to attend. The session management system 502 can generate and send notifications of the available sessions in the lists to the account holders or participants. For example, if the participant is skilled in a certain type of martial art, the session management system 502 can generate lists of martial art classes that are of the same type and for participants with the same skill level and send notifications of the listed classes to the account holder or the participant.

The participant information received by the communication interface 514, can also include participant feedback. The participant feedback can be received from the session organizer client device 518 and the instructor client device 520. The participant feedback engine can collect the participant feedback and store the participant feedback in the participant feedback datastore 508. The participant feedback can be stored with an identifier that uniquely identifies which participant the participant feedback describes. Additionally, the participant feedback can include participant performance information that describes how a participant performed at a session. Additionally, if the participant feedback can include how a participant performed in a test or pretest qualification. If the test or the pretest qualification involves multiple steps that are graded, the participant performance information can include the grades that the participant attained for each step of the test or pretest qualification. The participant feedback, including the participant performance information, can be provided by the instructor or the session organizer to the participant management system 504 during the session. Specifically, as the participant is performing a test, the instructor or session organizer can input participant feedback, including the grades of each step in a test, into the session organizer client device 518 or the instructor client device 520.

The participant management engine 510 can use the participant feedback to manipulate the participant data structure stored in the participant datastore 506. For example, if a participant passes a test, the instructor who administered the test can enter, as part of their participant feedback, that the participant passed the test. Similarly, if a participant meets the pretest qualifications to take a test, the instructor who administered the pretest qualifications can enter, as part of their participant feedback, that the participant is qualified to take the test. Additionally, the participant performance information can be used along with the test information in the test data structure to determine, by the participant management engine 510, whether the participant passed a test or met the pretest qualifications and the grades attained by the participant in the test of the pretest qualification. The participant management engine 510 can then update the participant data structure to reflect that the participant has passed the test, and whether or not the participant has obtained a new level by passing the test.

The participant management engine 510 can also generate participant progress reports from the participant data structures in the participant datastore 506. The participate progress reports can be sent by the participant management engine 510 through the communication interface to any of the session organizer client device 518, the instructor client device 520 or the account holder/participant client device 522.

In the operation of the example system in FIG. 5, the session management system 502, the participant management system 504, the session organizer client device 518, the instructor client device 520 and the account holder/participant client device 522 can communicate with each other through the computer readable medium 516. Communicating can include exchanging instruction data. The participant management system 504 can receive and send data through the communication interface 514.

More specifically, in the operation of the example system in FIG. 5, the participant management system 504 can receive participant information, including identification information of the participant, skills and expertise information of the participant and participant feedback. The participant management engine 510 can create participant data structures for participants stored in the participant datastore 506. The participant management engine 510 can manipulate the participant data structure based on participant information and participant feedback.

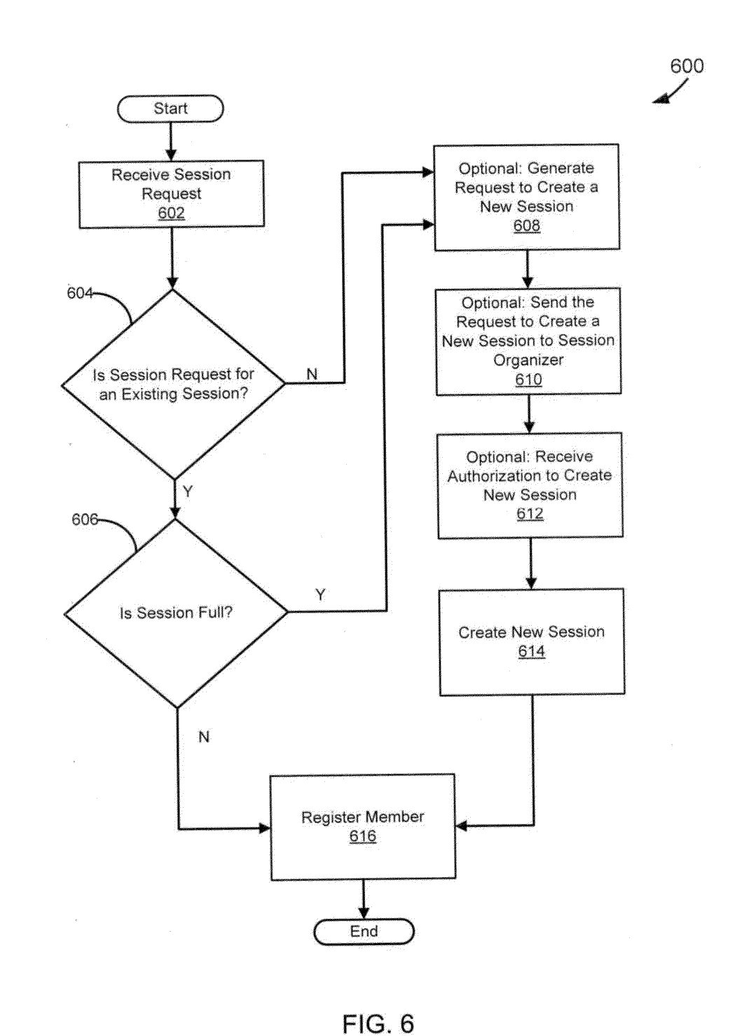

FIG. 6 depicts a flowchart 600 of an example of a method for creating and managing sessions. The flowchart 600 begins at module 602, with receiving a session request. The session request can be to create a new session or attend an existing session. The session request can be received from any member, including a system organizer, an account holder, an instructor or a participant. The session request can include the identification information of the session that is the subject of the request.

The flowchart 600 continues to decision point 604, where it is determined if the session request is for an existing session. If, at decision point 604, it is determined that the session request is for an existing session, the flowchart 600 continues to decision point 606. If it is determined, at decision point 604, that the session request is not for an existing session, e.g. a new session, the flowchart 600 continues to module 608.

At decision point 606, it is determined whether the existing session is full. Whether a session is full can be determined by the session management system, as described in this paper, from the session information. If at decision point 606, it is determined that the session is full, the flowchart 600 continue to module 608. If at decision point 606, it is determined that the session is not full, the flowchart continues to module 616, where a member who either made the session request or is associated with the session request is registered for the existing session. For example, if a parent makes a request for a specific martial art class that is existing and is not full, then the child of the parent can be registered for the specific martial art class.

At module 608, the flowchart 600 optionally includes generating a request to create a new session. The generated request to create a new session can be for a session that is associated with the existing session that is full, or for a session that is specified in the session request received at module 602. The flowchart 600 continues to module 610, where optionally, the generated request to create a new session is sent to the session organizer 610. The flowchart 600 then continues to module 612, where optionally, authorization to create the new session is received. The authorization to create the new session can be received from the session organizer in response to the generated request to create the new session sent to the session organizer.

At module 612, the flowchart 600 continues to module 614, where the new session is created. In creating the new session, the session management system can update the session information to reflect the new session. Next, the flowchart continue to module 616, where the member is registered for the session. Registering the member at module 616 can include registering the member for the new session.

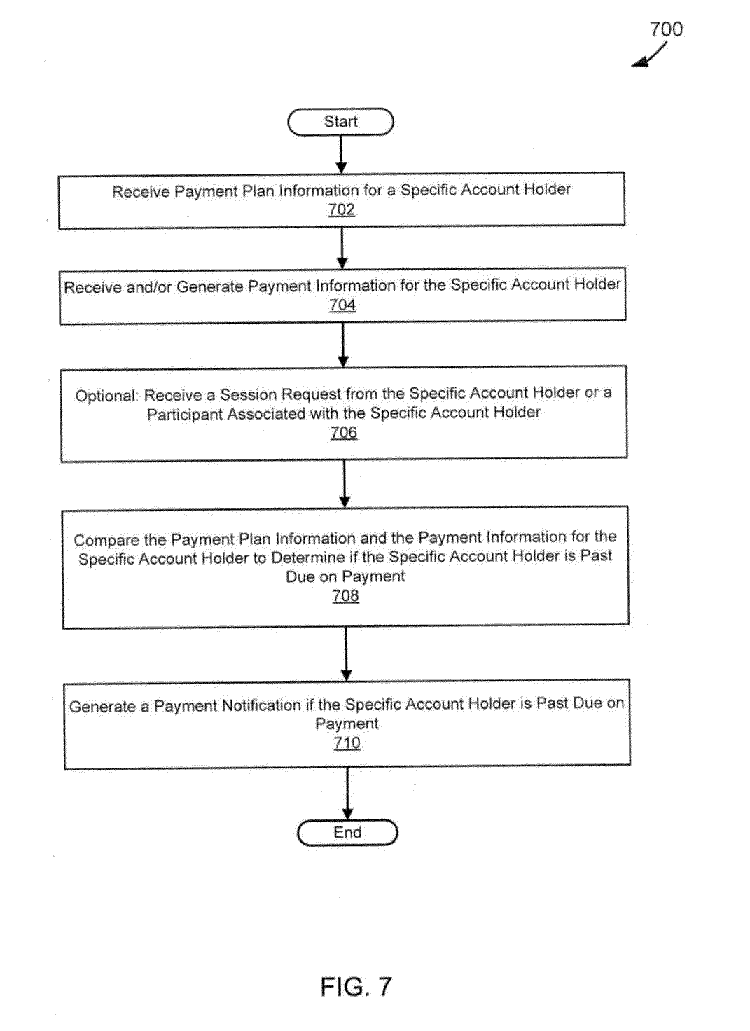

FIG. 7 depicts a flowchart 700 of an example of a method for determining whether an account holder is past due on payment. The flowchart 700 begins at module 702 with receiving payment plan information for a specific account holder. The payment plan information for a specific account holder can be received from a session organizer client device, an instructor client device or an account holder/participant client device. The payment plan information can include the number of prepaid sessions that an account holder or a participant associated with the account holder is allowed to attend for a given period of time.

The flowchart 700 continues to module 704, where payment information for the specific account holder is either received or generated. The payment information that is received from the account holder can include information that allows for a transaction to occur. The payment information that is generated can include the number of payments that are made or whether a payment has been made or not.

The flowchart 700 continues to module 706 with optionally receiving a session request from the specific account holder or a participant associated with the specific account holder. The flowchart 700 then continues to module 708 where the payment plan information and the payment information for the specific account holder are compared to determine if the specific account holder is past due on payment. Additionally, at module 708, the payment plan information, the payment information can be compared with the session information to determine whether the account holder is past due on payment. Specifically, the session information can be used to determine the number of sessions that the account holder or a participant associated with the account holder are registered to attend or have attended to determine whether or not the number of sessions exceeds the amount that have been paid for or are included in the payment plan.

The flowchart 700 then continues to module 710 where a payment notification indicating that the specific account holder is past due on payment is generated when the account holder is past due on payment. The notification can be automatically sent to the specific account holder or be sent to the session organizer The session organizer can determine whether to send the notification to the account holder. If the session organizer chooses to not send the notification, it can still be included as part of the account holder information and used at a later point in time.

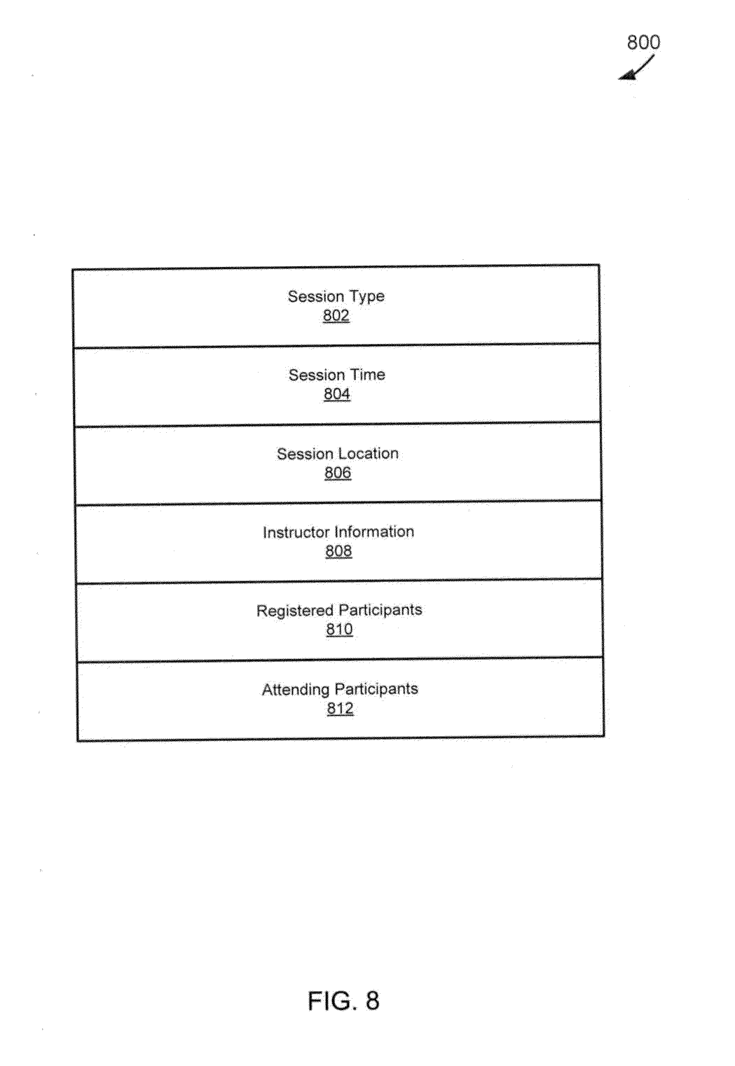

FIG. 8 depicts an example session data structure 800 for a session. The session data structure includes a session type 802, a session time 804, a session location 806, instructor information 808, registered participants 810 and attending participants 812.

The session data structure 800 as a whole can be manipulated or created by the schedule management engine. Specifically, the schedule management engine can create or delete the session data structure 800. The schedule management engine can create or delete the session data structure 800 in response to instructions or session requests from the session organizer who is authorized to create or cancel session.

The session type 802 includes the type of session to which the data structure corresponds. For example, if the session is for a specific type of martial art, the session type 802 can be the specific type of martial art that will be taught at the session. The session type 802 can also include the characteristics of the session including what tests or pretests, if any, will be administered at the session.

The session time 804 includes the time that the session will be conducted. The session time 804 can be determined and changed by the schedule management engine. Using the schedule management engine, an instructor or a session organizer can be authorized to determine or change the session time 804.

The session location 806 includes the location at which the session will be conducted. The session location 806 can be determined and change by the schedule management engine. Using the schedule management engine, an instructor or a session organizer can be authorized to determine or change the session location 806.

The instructor information 808 includes the instructor information of the instructor assigned to the session. The instructor can be assigned to the session by the instructor assignment engine. The instructor information 808 can be obtained from the instructor data structure in the instruction management system. The instructor information can include the identification of the instructor, the contact information of the instructor and the skills and expertise of the instructor.

The registered participants 810 includes the participant information of the participants who are registered to attend the session to which the session data structure 800 corresponds. The schedule management engine can generate and change the registered participants 810 based on instructions or requests received from the session organizer, the participants, the account holders or an instructor. The participant information can include the identification information and the skills and expertise of the participants who are registered to attend the session.

The attending participants 812 includes the participant information of the participants who actually attend the session. The session attendance engine can generate and change the attending participants 812 based on attendance information received from the session organizer, the instructor, the account holder or the participants.

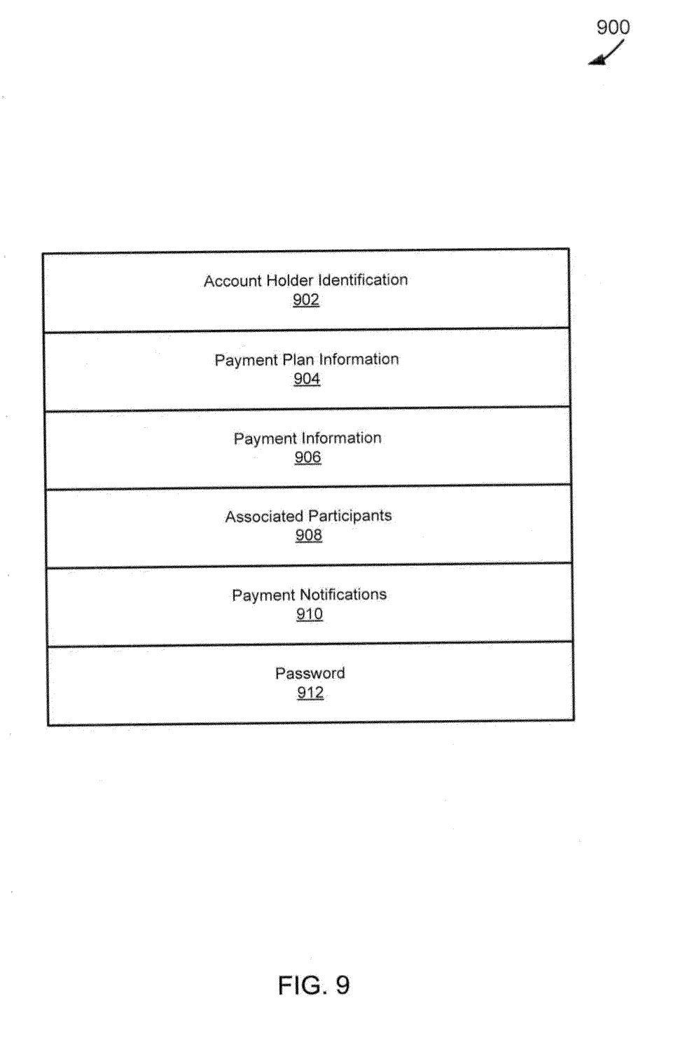

FIG. 9 depicts an example account holder data structure 900 for an account holder. The account holder data structure 900 includes account holder identification 902, payment plan information 904, payment information 906, associated participants 908, associated sessions 910 and password information 912.

The account holder identification 902 can include the identification of the account holder and contact information of the account holder. The account holder identification can be created and manipulated by the account holder through the account holder management engine. Specifically, the account holder can manipulate the account holder identification to include updated contact information.

The payment plan information 904 includes the specific payment plan that an account holder has signed up for. The payment plan information 904 can be created and manipulated by the account holder or the session organizer through the account holder management engine. For example in manipulating the payment plan information 904, an account holder or a session organizer can change the payment plan of the account holder.

The payment information 906 includes the payment information of an account holder. The payment information can include credit card information or any other information that can be used to make a transaction. The payment information can also include any transactions that have been made or whether a transaction has ever been made. The account holder, the session organizer or instructor can create and manipulate the payment information through the account holder management engine. For example, the session organizer or instructor can process a payment transaction at a session and change the payment information to reflect the processed payment transaction.

The associated participants 908 includes the identification of the participants that are associated with the account holder. The associated participants can be created and manipulated by the account holder of the session organizer through the account holder management engine. The payment notifications 910 includes the payment notifications that are generated for the account holder. The payment notifications can be created by the payment notification engine. The payment notifications can be manipulated by the account holder management engine or the session organizer through the account holder management engine. For example, in manipulating the payment notification, a session organizer can choose not to send the notification to the account holder and mark the notification as obsolete.

The password information 912 includes the password that can be used by members in accessing the account holder data structure 900. The password information can be created and manipulated by the session organizer and the account holder. Specifically, the account holder can change the password to a new password and manipulate the password information to include the new password.

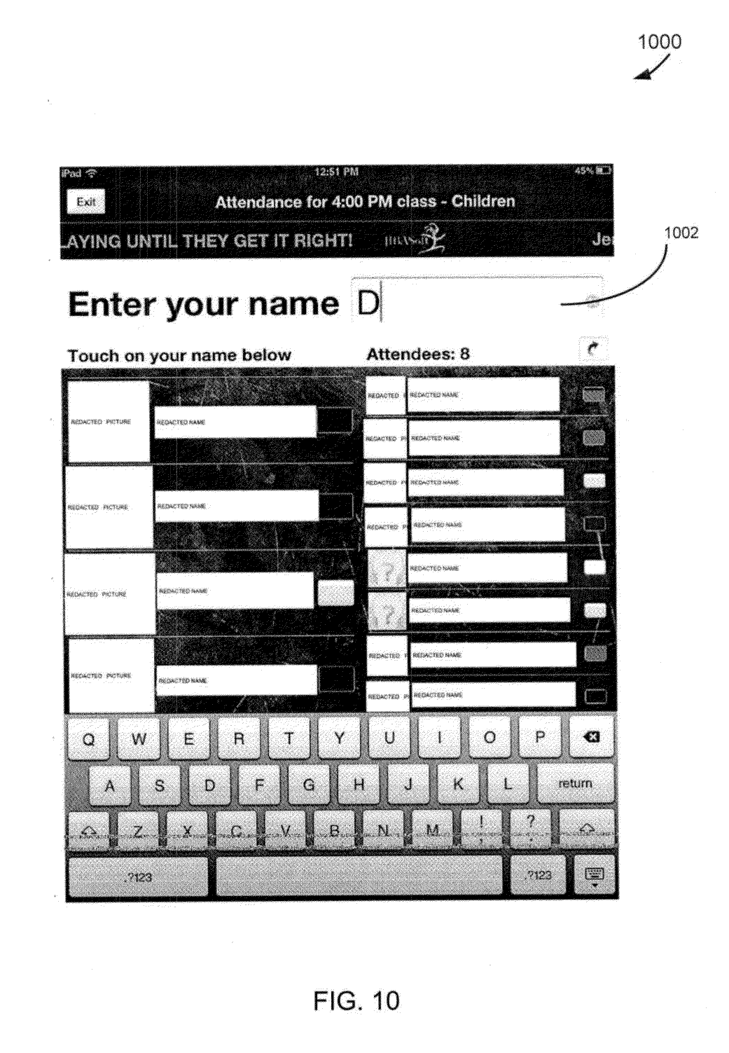

FIG. 10 illustrates an example of a screen depicting an interface 1000 through which an account holder or a participant can input participant information related to generating a request for a session. The interface includes a field 1002 through which an account holder or a participant can input participant identification information for a session. The interface also includes displays of the participant information of other participants for a session.

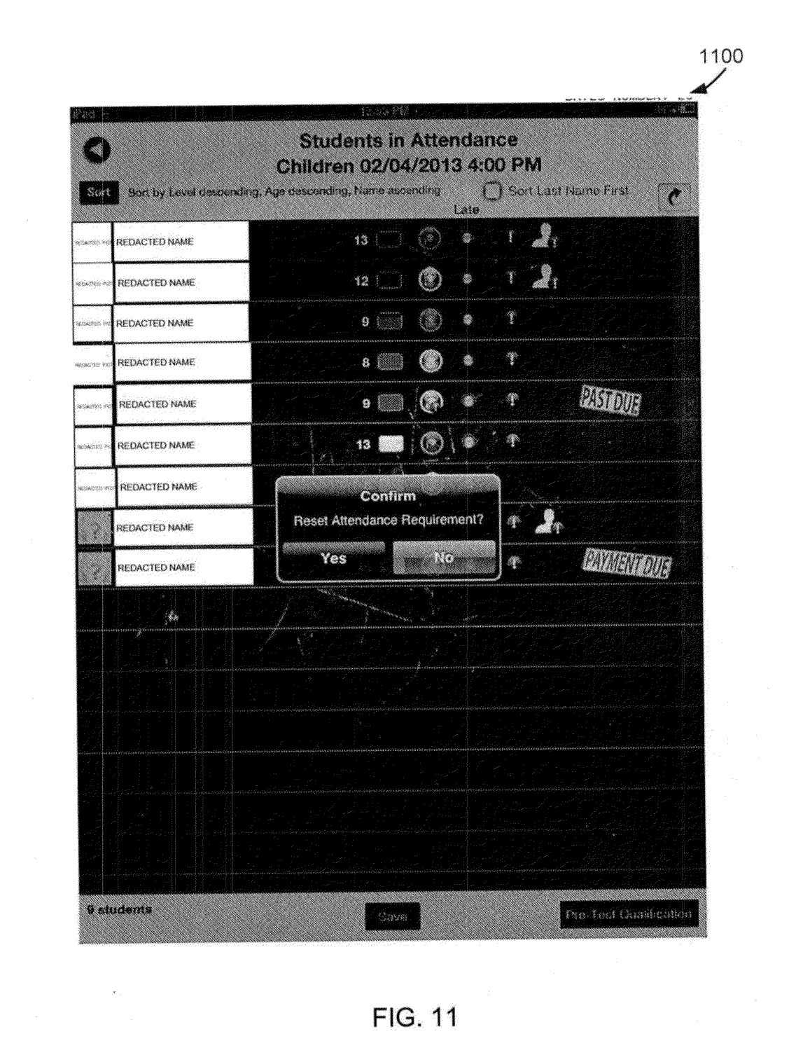

FIG. 11 illustrates an example of a screen depicting an interface 1100 through which a session organizer can view attendance reports and account holders are past due payment. Specifically, the interface 1100 includes a list of the participants who are registered to attend a session. The interface also includes indicia indicating which participants are past due payment next to the participants that are associated with the account holders who are past due payment.

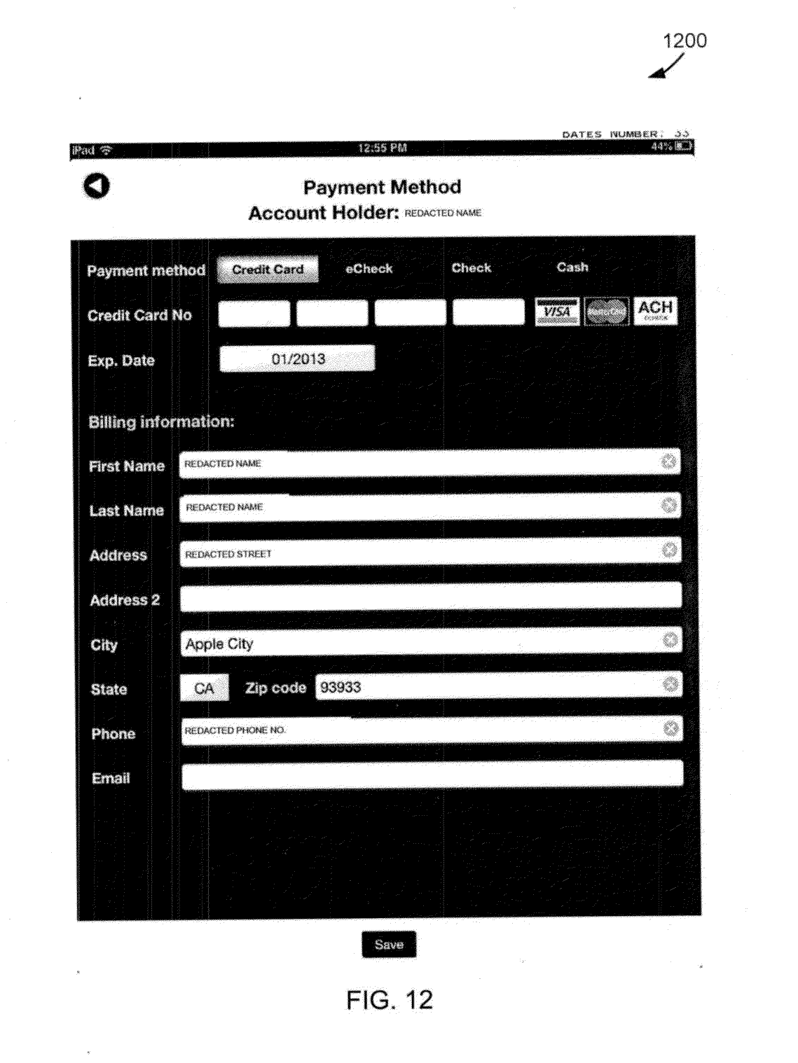

FIG. 12 illustrates an example of a screen depicting an interface 1200 through which a session organizer or an account holder can submit payment information. Specifically, the interface includes fields through which an account holder or a session organizer can input payment information including credit card information. The interface 1200 also includes fields through which a session organizer or an account holder can input identification information of the account holder along with the payment information.

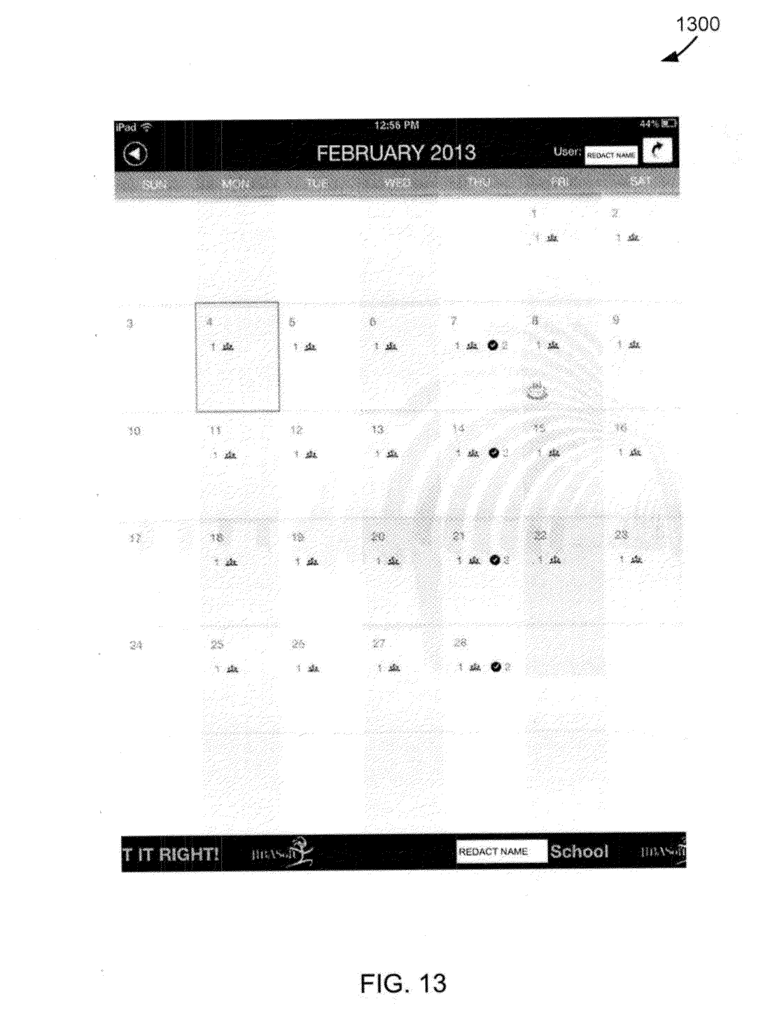

FIG. 13 illustrates an example of a screen depicting an interface 1300 that includes session information. The session information is illustrated as a calendar in the interface 1300. The calendar can be interactive, in that a member, including a session organizer can select a date and be presented with all of the session data for the selected date.

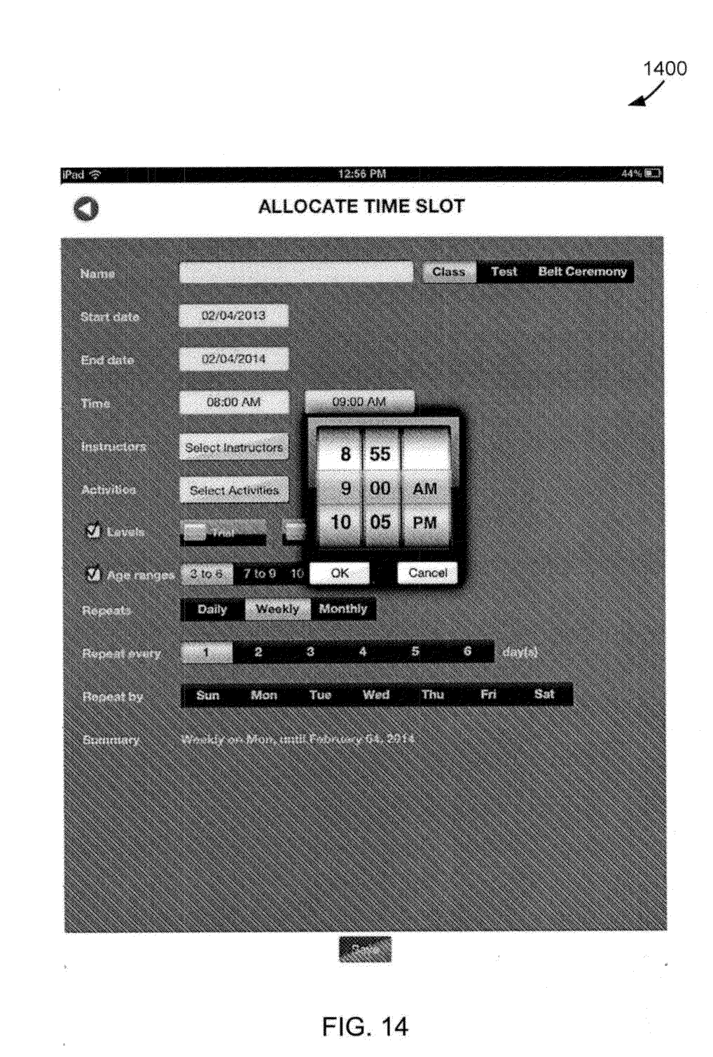

FIG. 14 illustrates an example of a screen depicting an interface 1400 through which a session organizer or instructor can create new sessions. Specifically, the interface 1400 includes fields through which the name of the session can be entered. The interface 1400 also includes time fields through which a member can schedule times for the session. Additionally, the interface 1400 includes icons that can be used to schedule the session at repeated times in a duration of time. For example, the interface 1400 includes a weekly icon that can be activated at to create the session at the same time each week.

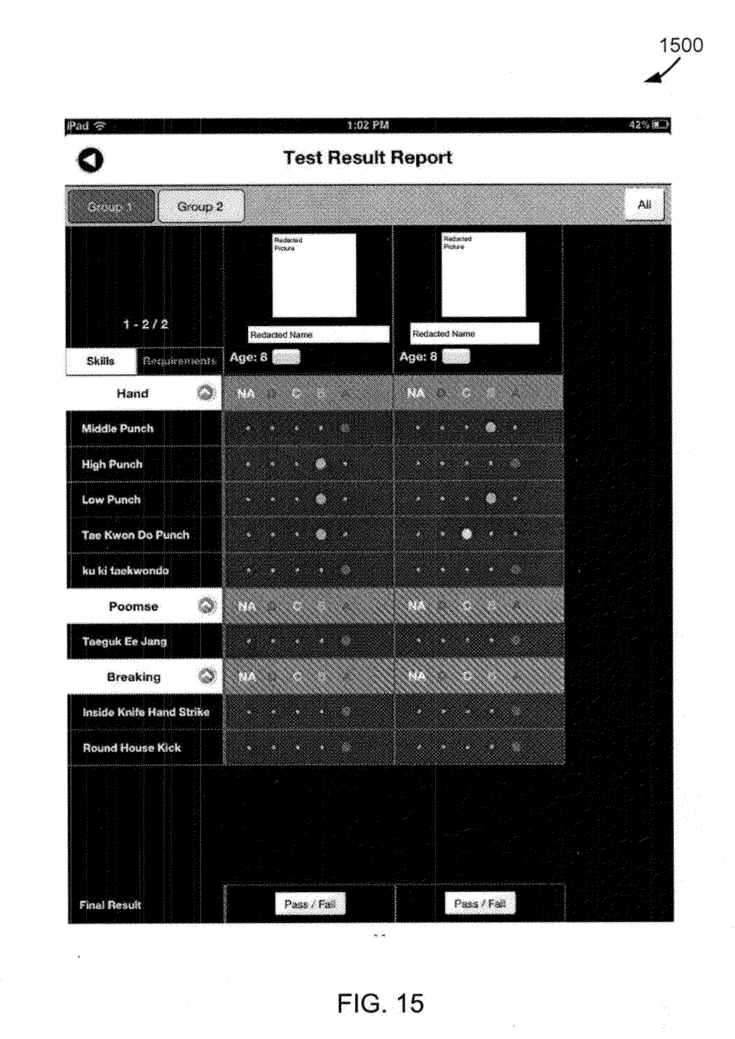

FIG. 15 illustrates an example of a screen depicting an interface 1500 that displays a report illustrating participant information. The report includes how a participant performed in a test. Specifically, the report includes each step as part of a test and how the participant performed in each step. The participant information that is used to form the report can be generated by an instructor.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
registering an account holder and a participant, including creating an account holder data structure and a participant data structure, the account holder data structure including account holder information and the participant data structure including participant information;
registering a participant to attend a session;
receiving participant feedback during the session from an instructor, the participant feedback including participant performance information that describes how the participant performed during the session;
manipulating the participant data structure so that the participant information includes the participant performance information;
generating a participant progress report based on the participant data structure;
allowing the account holder to view the participant progress report.

2. The method of claim 1, further comprising:
determining attendance data of the participant from session data structures of sessions that the participant attends;
determining from the attendance data and the account holder information in the account holder data structure whether the account holder is past due in payment;
generating a payment notification for the account holder if the account holder is past due in payment.

3. The method of claim 2, wherein the account holder information includes payment information and payment plan information of the account holder, the payment information and the payment plan information of the account holder used to determine if the account holder is past due in payment.

4. The method of claim 2, further comprising:
sending the payment notification to a session organizer;
determining, by the session organizer, whether to give authorization to send the payment notification to the account holder;
sending the payment notification to the account holder if the session organizer gives authorization to send the payment notification to the account holder.

5. The method of claim 1, wherein the account holder and the participant are registered on-site at a location of the session and the participant is registered to attend the session on-site at the location of the session.

6. The method of claim 1, wherein the account holder information includes payment information and payment plan information, the payment plan information including a first payment plan, the method further comprising:
receiving a second payment plan from the account holder at the session, the second payment plan being different from the first payment plan and being the payment plan under which the account holder wants to pay under;
manipulating the account holder data structure so that the payment plan information includes the second payment plan.

7. The method of claim 1, wherein the account holder information includes payment information and payment plan information, the method further comprising:
receiving a payment from the account holder at the session;
manipulating the account holder data structure so that the payment information includes the payment.

8. The method of claim 1, further comprising:
determining attendance data of the session from a session data structure of the session;
generating an attendance report of the session from the attendance data of the session;
sending the attendance report of the session to a session organizer.

9. The method of claim 1, further comprising:
receiving test information of a test, the test information including steps in the test;
using the test information to create a test data structure that include the test information;
providing, to the instructor, access to the test data structure;
generating, by the instructor, grades for the participant in performing the steps in the test, the grades included as part of the participant feedback.

10. The method of claim 9, further comprising:
determining whether the participant has passed the test based on the participant feedback and rules of the test, the rules of test included as part of the test information included in the test data structure;
manipulating the participant data structure so that the participant information includes that the participant passed the test, if it is determined that the participant passed the test.

11. A system comprising:
means for registering an account holder and a participant, including creating an account holder data structure and a participant data structure, the account holder data structure including account holder information and the participant data structure including participant information;
means for registering a participant to attend a session;
means for receiving participant feedback during the session from an instructor, the participant feedback including participant performance information that describes how the participant performed during the session;
means for manipulating the participant data structure so that the participant information includes the participant performance information;
means for generating a participant progress report based on the participant data structure;
means for allowing the account holder to view the participant progress report.
